(19) United States
(12) Patent Application Publication
(10) Pub. No.: US 2010/0289700 A1
(43) Pub. Date: Nov. 18, 2010

(54) Multi-band antenna

(76) Inventors: Chung-Wen Yang, Tu-Cheng City (TW); Yu-Yuan Wu, Tu-Cheng City (TW); Hung-Jen Chen, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,572

(22) Filed: May 15, 2009

(51) Int. Cl. H01Q 1/38

(52) U.S. Cl. 343/700 MS

(57) ABSTRACT

A multi-band antenna includes a first radiator resonating at a high frequency bans and a second radiator extended from a first end and toward a second end of the first radiator, and resonating at a low frequency range. An opening slot is formed between the first and the second radiators. A connecting slot and an end slot are formed in the second radiator. The width of the connecting slot is wider than the width of the opening slot. The connecting slot can prevent vectors potential caused by the second radiator from being neutralized. The electromagnetic coupling effect over the opening slot caused by the first radiator and the second radiator can pull down the low frequency range for reducing the size of the second radiator. Therefore, the multi-band antenna has a small size.

### BACKGROUND OF THE INVENTION

1. Field of the Invention

The present invention relates to an antenna, more specifically, to a multi-band antenna.

2. The Related Art

According to the progress of the communication technology, telecommunication system has become more popular nowadays. A transceiver and an antenna are components of telecommunication system. Due to the antenna capable of transferring current into radio wave and transferring radio wave into current, it is a major component in telecommunication system. Thus, efficiency and gain of the antenna directly may affect the quality of voice in telecommunication system.

The mobile phone is one of essential apparatus used in telecommunication system. For the marketing purposes, the essential requirements of the mobile phone are compact size and multi-band operation. Therefore, the antenna needs to become small size and multi-band operation in accordance with the essential requirements of the mobile phone.

Please refer to FIG. 4, it shows a conventional antenna 900 with small size. The antenna 900 has a first radiating portion 902, a second radiating portion 904, a feeding portion 906 and a grounding portion 908. The first radiating portion 902 is of a rectangle shape with opposite a first end portion 910 and a second end portion 912.

The feeding portion 906 is arranged to near the grounding portion 908, and both the feeding portion 906 and the grounding portion 908 are extended from a first side of the first end portion 910 of the first radiating portion 902. The second radiating portion 904 is extended form a second side of the first end portion 910 of the first radiating portion 902, which has a meandering portion 914 and a L-shaped portion 916.

The meandering portion 914 has a third end portion 918 connected to the first end portion 910 of the first radiating portion 902, and a fourth end portion 920 connected to the L-shaped portion 916. The first radiating portion 902 of the antenna 900 can resonate at a low frequency range and the second radiating portion 904 can resonate at a high frequency range. Thus, the antenna 900 can achieve multi-band operation. According to the arrangement of the meandering portion 914, the antenna 900 has an advantage of smaller size.

However, the arrangement of the meandering portion 914 of the antenna 900 may cause frequency shifting. Because the neighbor sections in the meandering portion 914 are close to each other, the current passing though the meandering portion 914 substantially forms a first current flow I and a second current flow I′ opposite to the first current flow I.

Thus, the vector potential caused by the first current direction may neutralize the vector potential caused by the second current direction. Especially, a self-inductance of the meandering portion 914 is therefore reduced. Because the low frequency range resonated by the second radiating portion 904 and the self-inductance of the meandering portion 914 are an inverse proportion, the frequency range may shift to close the high frequency range.

Thus, the length of the L-shaped portion 916 or the total length of the second radiating portion 904 may be increased for pull down the low frequency range into the predetermination frequency range. Therefore, the size of the antenna 900 can not be obviously reduced on account of the arrangement of the meandering portion 914.

### SUMMARY OF THE INVENTION

An object of the present invention is to provide a multi-band antenna including a first radiating portion and a second radiating portion. The first radiating portion has a first end portion and a second end portion. The second radiating portion extends from the first end portion and toward the second end portion of the first radiating portion.

A gap is formed between the first radiating portion and the second radiating portion. The gap has an opening slot, a connecting slot and an end slot. The opening slot is formed between the first radiating portion and the second radiating portion. The connecting slot and the end slot are together formed in the second radiating portion. The width of the connecting slot is wider than the width of the opening slot.

The first radiating portion can resonate at a high frequency range, and the second radiating portion can resonate at a low frequency range. The connecting slot of the gap can prevent the vectors potential caused by the second radiating portion from being neutralized.

The electromagnetic coupling effect over the opening slot of the gap caused between the first radiating portion and the second radiating portion can pull down the low frequency range for reducing the size of the second radiating portion. Therefore, the multi-band antenna has a small size.

### BRIEF DESCRIPTION OF THE DRAWINGS

The present invention will be apparent to those skilled in the art by reading the following description of preferred embodiments thereof, with reference to the attached drawings, in which:

FIG. 1 shows a first preferred embodiment of a multi-band antenna printed on a printed circuit board according to the present invention;

FIG. 2 shows a second preferred embodiment of the multi-band antenna made of a metallic foil according to the present invention;

FIG. 3 shows a Voltage Standing Wave Ratio (VSWR) test chart of the multi-band antenna according to the present invention; and

FIG. 4 shows a conventional antenna.

### DETAILED DESCRIPTION OF THE PREFERRED EMBODIMENT

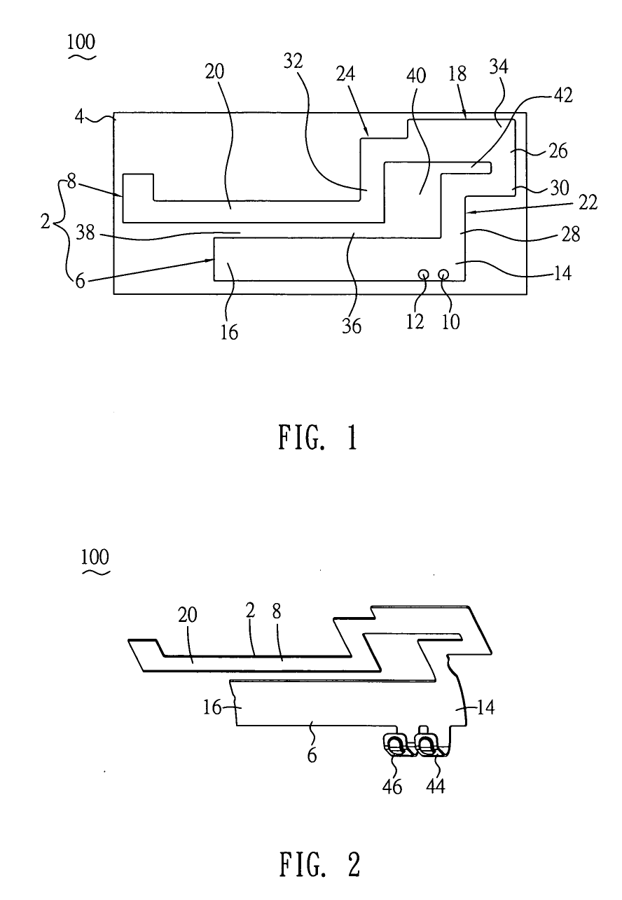

Please refer to FIG. 1. A first preferred embodiment of a multi-band antenna 100 includes an antenna unit 2 and a printed circuit board 4. The antenna unit 2 printed on the printed circuit board 2 has a first radiating portion 6, a second radiating portion 8, a feeding point 10 and a grounding point 12.

The first radiating portion 6 is of rectangle shape has a first end portion 14 and a second end portion 16 opposite to the first end portion 14. The feeding point 10 is arranged to near the grounding point 12, and both of the feeding point 10 and the ground point 12 are arranged at the first end portion 14 of the first radiating portion 6.

The second radiating portion 8 is extended from the first end portion 14 of the first radiating portion 6 and extended toward the second end portion 16 of the first radiating portion 6. The second radiating portion 8 has a first radiating section 18 and a second radiating section 20. The first radiating section 18 has a first L-shaped section 22, a second L-shaped section 24 and a connecting section 26. The first L-shaped section 22 and the second L-shaped section 24 are arranged to parallel to each other.

The first L-shaped section 22 has a third end portion 28 connected to the first end portion 14 of the first radiating portion 6, and a fourth end portion 30 connected to one end of the connecting section 26. The second L-shaped section 24 has a fifth end portion 32 connected to the second radiating section 20, and a sixth end portion 34 connected to the other end of the connecting section 26. The second radiating section 20 is arranged to parallel to the first radiating portion 6.

The first radiating portion 6 and the second radiating portion 8 together form a gap 36 therebetween. The gap 36 is consisted of an opening slot 38, a connecting slot 40 and an end slot 42. The opening slot 38 is formed between the first radiating portion 6 and the second radiating section 20 of the second radiating portion 8.

The connecting slot 40 interconnects the opening slot 38 and the end slot 42. The connecting slot 40 and the end slot 42 are together formed among the first L-shaped section 22, the second L-shaped section 24 and the connecting section 26 of the first radiating section 18 of the second radiating portion 8. Especially, the connecting slot 40 and the end slot 42 are together of a L-shaped.

The width of the connecting slot 40 is wider than the width of the opening slot 38 and the width of the end slot 42. The gap 36 consisted of the opening slot 38, the connecting slot 40 and the end slot 42 is of a stair-shaped.

Please refer to FIG. 2, it shows a second preferred embodiment of the multi-band antenna 100. In this case, The antenna unit 2 of the multi-band antenna 100 is made of a metallic foil and stamped to a folded shape. A feeding portion 44 and a grounding portion 46 are extended from the first end portion 14 of the first radiating portion 6.

The feeding portion 44 and the grounding potion are arranged to near to each other. Both the feeding portion 44 and the grounding portion 46 are of a curved shape for elastically pressing onto corresponding pads of a printed circuit board of a mobile phone (not shown in figures). Especially, the free end of the second radiating section 20 of the second radiating portion 8 may be extended and curved for tuning a frequency range of the multi-band antenna 100.

Because the width of the connecting slot 40 arranged between the first L-shaped section 22 and the second L-shaped section 24 is wide, the first L-shaped section 22 is spaced away the second L-shaped section 24. Thus, a vector potential caused by a current flow passing through the second L-shaped 24 will prevent a vector potential caused by a current flow passing through the first L-shaped section 22 from being neutralized.

Because the width of the opening slot 38 arranged between the first radiating portion 6 and the second radiating section 20 of the second radiating portion 8 is narrow, and a current flow passing through the first radiating portion 6 and a current flow passing through the second radiating section 20 of the second radiating portion 8 are in the same direction, an electromagnetic coupling effect therebetween may pull down the low frequency range caused by the second radiating portion 8.

Thus, the length of the second radiating section 20 of the second radiating portion 8 or the total length of the second radiating portion 8 is reduced. The size of the multi-band antenna 100 is therefore reduced.

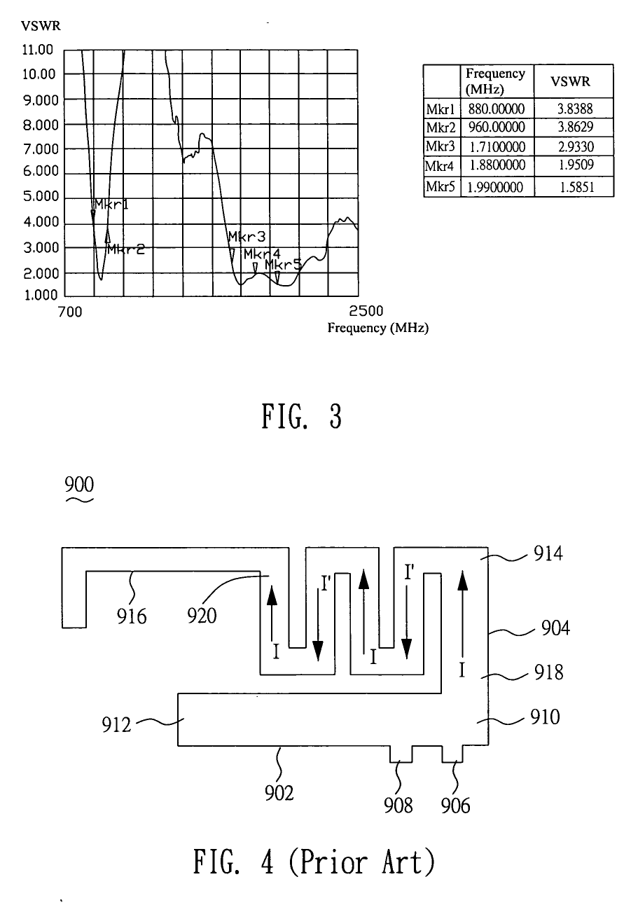

Please refer to FIG. 3, it shows a Voltage Standing Wave Ratio (VSWR) test chart of the multi-band antenna 100. If the multi-band antenna 100 operates at 880 MHz, then the VSWR value is 3.8388 (Mkr1 in FIG. 3). If the multi-band antenna 100 operates at 960 MHz, then the VSWR value is 3.8629 (Mkr2 in FIG. 3).

If the multi-band antenna 100 operates at 1710 MHz, then the VSWR value is 2.933 (Mkr3 in FIG. 3). If the multi-band antenna 100 operates at 1880 MHz, then the VSWR value is 1.9509 (Mkr4 in FIG. 3). If the multi-band antenna 100 operates at 1990 MHz, then the VSWR value is 1.5851 (Mkr5 in FIG. 3). Thus, the multi-band antenna 100 may stably operates at EGSM 900 MHz band, DCS 1800 MHz band and PCS 1900 MHz band of Global System for Mobile Communication (GSM).

As described above, the first radiating portion 6 can resonate at the high frequency range covering DCS 1800 MHz band and PCS 1900 MHz band. The second radiating portion 8 can resonate at low frequency range covering EGSM 900 MHz band. Therefore the multi-band antenna 100 can operates at three frequency band of GSM.

The connecting slot 40 of the gap 36 can prevent vectors potential caused by the first L-shaped section 22 and the second L-shaped section 24 of the second radiating portion 8 from being neutralized each other. The electromagnetic coupling effect caused between the first radiating portion 6 and the second radiating section 20 of the second radiating portion 8 can pull down the low frequency range for reducing the size of the second radiating portion 8. Therefore, the multi-band antenna 100 has a small size.

Furthermore, the present invention is not limited to the embodiments described above; diverse additions, alterations and the like may be made within the scope of the present invention by a person skilled in the art. For example, respective embodiments may be appropriately combined.

What is claimed is:

1. An antenna, comprising:
a first radiating portion having a first end portion and a second end portion opposite to the first end portion;
a second radiating portion extending from the first end portion and toward the second end of the first radiating portion;
a gap formed between the first radiating portion and the second radiating portion, which comprises:
an opening slot formed between the first radiating portion and the second radiating portion; and
a connecting slot and an end slot formed in the second radiating portion, a width of the connecting slot being wider than a width of the opening slot.

2. The antenna as claimed in claim 1, wherein the second radiating portion has a first radiating section being of a bent shape and a second radiating section, the first radiating section interconnects the first radiating portion and the second radiating section, the second radiating section is parallel to the first radiating portion, the opening slot is formed between the first radiating portion and the second radiating section, the connecting slot and the end slot is formed in the first radiating section.

3. The antenna as claimed in claim 2, wherein the first radiating portion and the second radiating section are of a rectangle shape.

4. The antenna as claimed in claim 2, wherein the first radiating section comprises
a first L-shaped section having a third end portion connected to the first end portion of the first radiating portion, and a fourth end portion;
a second L-shaped section parallel with the first L-shaped section having a fifth end portion connected to the second radiating section and a sixth end portion; and
a connecting section interconnected to the fourth end portion of the first L-shaped section and the sixth end portion of the second L-shaped section.

5. The antenna as claimed in claim 4, wherein an area of the first L-shaped section adjacent to a first side of the end slot is smaller than an area of the second L-shaped section adjacent to the second side of the end slot opposite to the first side.

6. The antenna as claimed in claim 4, wherein the connecting slot and the end slot are together of a L-shaped, the gap is of stair-shaped.

7. The antenna as claimed in claim 2, wherein the free end portion of second radiating section is of L-shaped.

8. The antenna as claimed in claim 1, wherein the first radiating portion and the second radiating portion are printed on a printed circuit board.

9. The antenna apparatus as claimed in claim 8, wherein the first end portion of the first radiating portion has a feeding point and a grounding point near to the feeding point.

10. The antenna as claimed in claim 1, wherein the first radiating portion and the second radiating portion are made of a metallic foil and of one piece.

11. The antenna as claimed in claim 10, wherein a feeding portion and a grounding portion near to the feeding portion extend from an edge the first end portion of the first radiating portion.

12. The antenna as claimed in claim 11, wherein the feeding portion and the ground portion are of a curved shaped.

13. An antenna, comprising:
an antenna unit;
a gap formed in the antenna unit and comprising
an opening slot with a first width connected to outside, current flows on the antenna unit at opposite sides of the opening slot are in same direction;
an end slot with a second width, current flows on the antenna unit at opposite sides of the end slot are in opposite directions; and
a connecting slot with a third width wider than the first width of the opening slot, current flows on the antenna unit at opposite sides of the connecting slot are in opposite directions.

14. The antenna as claimed in claim 13, wherein the gap is of one of a stair-shaped and an inverse Z-shaped.

15. The antenna as claimed in claim 13, wherein the first width is equal to the second width.

16. An antenna, comprising:
a first conductor having a first side;
a bent conductor extended from a first end of the first side of the conductor;
a second conductor extended from the free end of the folded conductor and having a second side parallel to and near to the first side of the first conductor; and
a gap formed among the first conductor, the folded conductor and the second conductor, and comprising
an opening portion with a first width formed between the first conductor and the second conductor; and
a connecting portion with a second width and an end portion with a third width formed in the folded conductor, the second width being wider than the first width.

17. The antenna as claimed in claim 16, wherein the first width is equal to the third width.

18. The antenna as claimed in claim 17, wherein the gap is of one of a stair-shaped or an inverse Z-shaped.

19. The antenna as claimed in claim 17, wherein the first conductor is of a rectangle shape.

20. The antenna as claimed in claim 17, wherein the free end portion of the second conductor is of a L-shaped.
